(19) United States
(12) Patent Application Publication
(10) Pub. No.: US 2003/0144927 A1
(43) Pub. Date: Jul. 31, 2003

(54) System, program and method for determining optimal lot size

(76) Inventor: Ikuo Kawakami, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/348,336

(22) Filed: Jan. 22, 2003

(30) Foreign Application Priority Data
Jan. 29, 2002 (JP) 2002-20432

(51) Int. Cl. G06F 17/60

(52) U.S. Cl. 705/28

(57) ABSTRACT

An optimal lot size determining system according to the present invention, comprises an actual sales database for storing actual sales of an item, an item parameter database for storing parameters of the item, an item sales predicting device and an optimal lot size determining device. The item sales predicting device is connected with the actual sales database and/or the item parameter database and predicts sales of the item based on actual sales and/or parameters of the item. The optimal lot size determining device is connected with the item sales predicting device and the item parameter database, and obtains an inventory cost function of lot size of the item, for costs including costs for storage and interest and a handling cost function of lot size of the item, for costs at both sides of sending and receiving the item, based on sales predicted by the item sales predicting device and item parameters. The optimal lot size determining device further obtains a lot size of the item, minimizing a sum of the inventory cost and the handling cost, to determine an optimal lot size. Accordingly, use of a predicted value of sales of the item, allows a real-time optimization of lot size for minimizing a sum of costs.

### FIELD OF THE INVENTION

The present invention relates to a system, a program, a computer readable medium having a program stored thereon and a method for determining an optimal lot size of a distributed item. It relates particularly to a system, a program and a method for determining an optimal lot size of parts to be used in vehicles and the like. The term “item” hereinafter includes every kind of thing to be distributed and products and parts thereof.

### BACKGROUND OF THE INVENTION

For example, parts of vehicles and the like are manufactured in a parts manufacturer, checked for quality assurance in a brand manufacturer of vehicles and then sold through domestic and foreign sales hubs. The brand manufacturer of vehicles must have a good inventory of parts to deal with demands of the sales hubs. However, overstocked inventory of parts increases costs for storage and interest, thus badly affecting businesses.

Under the above situation, an idea of “supply chain management” has become a focus of attention for promptly responding to a change in the market, solving problems of “loss of sales opportunities” and “overstocked inventories” and improving cash flow efficiency in businesses. “Supply chain management” manages a flow of operations including acquisition, production, sales and distribution as “supply chain”. However, if an idea of “sell by one” employed in “supply chain management” is applied to the above distribution of parts from the parts manufacturer to the brand manufacturer of vehicles, a frequency with which the parts manufacturer sends parts and a frequency with which the brand manufacturer of vehicles receive them, will increase. Consequently distribution costs will increase as a frequency with which parts are sent and received increases, even though inventory costs might decrease as inventories at the brand manufacturer of vehicles decrease.

Thus the idea of “supply chain management” does not contribute to minimizing distribution costs of parts for the parts manufacturer and the brand manufacturer of vehicles in such a case as mentioned above.

Japanese patent publications unexamined Nos. 5-250395, 7-239884, 2000-20614, 2000-29964 and 2001-188851 disclose prior art concerning optimization of distribution of parts and the like. However, the prior art disclosed in the publications does not contribute to minimizing distribution costs of parts for the parts manufacturer and the brand manufacturer of vehicles in such a case as mentioned above, while taking into consideration both inventory costs and distribution costs for sending and receiving an item.

So, there is a need for minimization of distribution costs of an item for the parts manufacturer and the brand manufacturer of vehicles in such a case as mentioned above.

### SUMMARY OF THE INVENTION

An optimal lot size determining system according to the present invention, comprises an actual sales database for storing actual sales of an item, an item parameter database for storing parameters of the item, an item sales predicting device and an optimal lot size determining device. The item sales predicting device is connected with the actual sales database and/or the item parameter database and predicts sales of the item based on actual sales and/or parameters of the item. The optimal lot size determining device is connected with the item sales predicting device and the item parameter database, and obtains an inventory cost function of lot size of the item, for costs including costs for storage and interest and a handling cost function of lot size of the item, for costs at both sides of sending and receiving the item, based on sales predicted by the item sales predicting device and item parameters. The optimal lot size determining device further obtains a lot size of the item, minimizing a sum of the inventory cost and the handling cost, to determine an optimal lot size.

An optimal lot size determining program according to the present invention, functions in a system comprising an actual sales database for storing actual sales of an item and an item parameter database for storing parameters of the item. The optimal lot size determining program according to the present invention, realizes the functions of predicting sales of the item based on actual sales stored in the actual sales database and/or parameters of the item stored in the item parameter database and obtaining an inventory cost function of lot size of the item, for costs including costs for storage and interest and a handling cost function of lot size of the item, for costs at both sides of sending and receiving the item, based on the predicted sales and item parameters stored in the item parameter database. The optimal lot size determining program further realizes the function of obtaining a lot size of the item, minimizing a sum of the inventory cost and the handling cost, to determine an optimal lot size.

An optimal lot size determining method according to the present invention, is used in a system comprising an actual sales database for storing actual sales of an item and an item parameter database for storing parameters of the item. The optimal lot size determining method according to the present invention, comprises the step of predicting sales of the item based on actual sales stored in the actual sales database and/or parameters of the item stored in the item parameter database. The method comprises the step of obtaining an inventory cost function of lot size of the item, for costs including costs for storage and interest and a handling cost function of lot size of the item, for costs at both sides of sending and receiving the item, based on the predicted sales and item parameters stored in the item parameter database. The method further comprises the step of obtaining a lot size of the item, minimizing a sum of the inventory cost and the handling cost, to determine an optimal lot size.

According to the present invention, sales of an item are predicted based on actual sales and/or parameters of the item. Then an inventory cost function of lot size of the item, for costs including costs for storage and interest and a handling cost function of lot size of the item, for costs at both sides of sending and receiving the item, are obtained based on the predicted sales and item parameters. Further, a lot size of the item, minimizing a sum of the inventory cost and the handling cost, is obtained to determine an optimal lot size. Accordingly, use of a predicted value of sales of the item, allows a real-time optimization of lot size B for minimizing a sum of costs. Further, an optimal lot size may be determined, which minimizes a total cost including handling costs at both the sides sending and receiving lots of the item of trade.

In a preferred embodiment of the present invention, the sum J of the inventory cost and the handling cost represented by the equation

$$J = ( E + R ) \cdot Z / B + ( A + I \cdot W ) \cdot B / 2$$

is defined and B is determined in such a way as to minimize J. Accordingly, an optimal lot size that minimizes the total cost, may be simply determined.

In another preferred embodiment of the present invention, the inventory cost further includes cost for unsold inventory risk. Thus, according to the preferred embodiment of the present invention, an optimal lot size that minimizes a sum of costs, further including cost for unsold inventory, may be determined.

### DESCRIPTION OF THE DRAWINGS

FIG. 1 shows a configuration of an optimal lot size determining system according to an embodiment of the present invention;

FIG. 2 is a flowchart showing a method for determining an optimal lot size according to an embodiment of the present invention;

FIG. 3 shows relationships between lot size and costs;

FIG. 4 shows relationships between lot size and costs;

FIG. 5 shows relationships between lot size and costs;

FIG. 6 shows a change in the number of parts at the brand manufacturer of vehicles; and

FIG. 7 shows a change in the number of parts at the brand manufacturer of vehicles.

### DETAILED DESCRIPTION OF THE PREFERRED EMBODIMENTS

In the preferred embodiments of the invention, an item is represented as a part. Cases where an item is a product and the like other than a part will also fall within the scope of the claims of the present invention. At first, parameters used hereinafter will be described. “A” represents cost for storage of a part for a unit of time. “B” represents a lot size of parts or the number of parts in a lot of parts. “E” represents handling cost for a lot of parts at the brand manufacturer of vehicles (the receiving side of lots of parts). “R” represents handling cost for a lot of parts at the parts manufacturer (the sending side of lots of parts). It is assumed that handling costs are proportional to the number of lots. It is further assumed that costs proportional to an amount of parts can be excluded. “W” represents a unit price of a part. “I” represents interest for a unit of time. “Z” represents a predicted value of sales of parts for a unit of time. A unit of time is defined in such a manner as to cope with a change in each parameter.

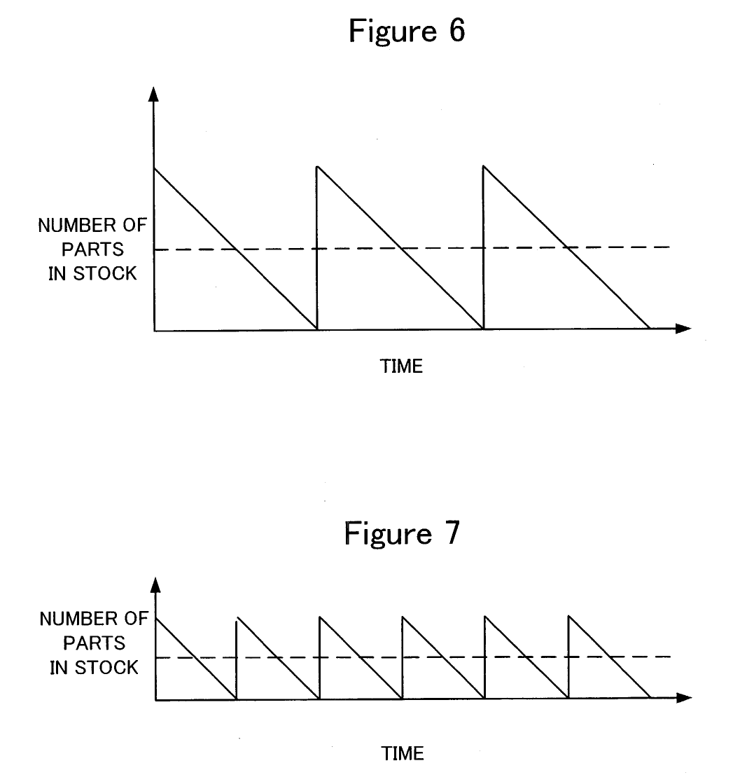

Inventory cost such as storage cost of parts and handling cost of parts will be described below according to FIGS. 6 and 7. FIG. 6 shows a change in the number of parts at the brand manufacturer of vehicles. In FIG. 6 the horizontal axis indicates time while the vertical axis indicates the number of parts. It is assumed that the brand manufacturer of vehicles receives parts in lots of lot size B, from the parts manufacturer. The number of parts is B when parts are received for the first time and decreases as some of the parts are sold with the passage of time. In the interests of simplicity it is assumed that the number of parts decreases as a linear function of time and another lot is received when the number of parts becomes zero.

The number of parts in stock averages B/2 over time and the average value is shown with a dotted line. Accordingly, cost D for storage of all the parts for a unit of time is represented as below.

D=A·B/2 (1)

Cost F for interest of all the parts for a unit of time is represented as below.

F=I·W·B/2 (2)

Further, the brand manufacturer of vehicles receives parts the number of which corresponds to sales Z of parts, from the parts manufacturer in lots having lot size B. So, a total handling cost H at the parts manufacturer and the brand manufacturer of vehicles, is represented as below.

H=(E+R)·Z/B (3)

FIG. 7 shows a change in the number of parts at the brand manufacturer of vehicles as in the case shown in FIG. 6. In FIG. 7, however, lot size B is smaller than that in FIG. 6. If lot size B is a half of that in FIG. 6, for example, cost D for storage of all the parts for a unit of time and cost F for interest of all the parts for a unit of time will be a half of those shown in FIG. 6, according to equations (1) and (2). However, if the sales remain unchanged, the number of lots will be doubled since the lot size is reduced to a half. Accordingly, handling cost H at the parts manufacturer and the brand manufacturer of vehicles, will be doubled according to equation (3).

Under the above situation the present invention minimizes distribution costs of parts for the parts manufacturer and the brand manufacturer of vehicles.

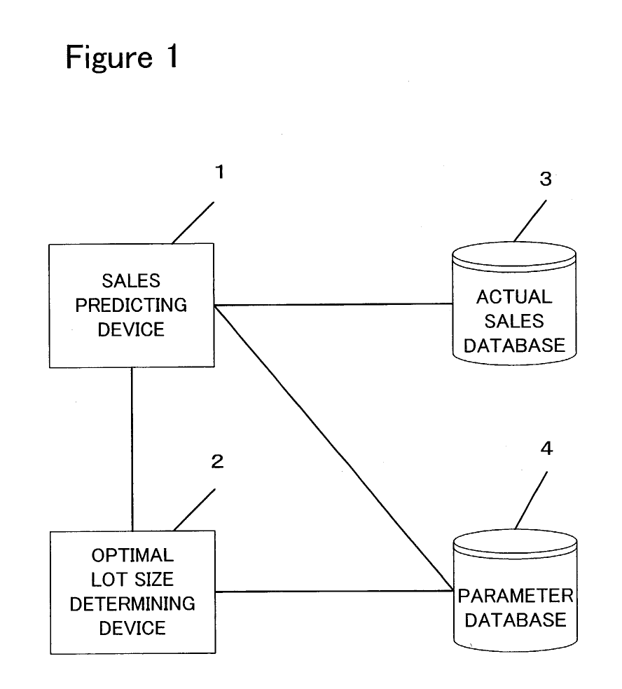

FIG. 1 shows a system configuration according to an embodiment of the present invention. A sales predicting device for predicting sales of parts, is shown with reference numeral 1. An optimal lot size determining device for determining an optimal lot size of parts, is shown with 2. An actual sales database for storing actual sales for each kind of parts, is shown with 3. A parameter database for storing parameters of parts, is shown with 4.

In the embodiment the sales predicting device, shown with 1 is connected with the actual sales database, shown with 3 and the parameter database, shown with 4. The sales predicting device predicts sales of parts based on actual sales and parameters of parts. The optimal lot size determining device, shown with 2 is connected with the sales predicting device, shown with 1 and the parameter database, shown with 4. The optimal lot size determining device determines an optimal lot size for receiving parts, based on sales predicted by the sales predicting device and parameters of parts. The sales predicting device, shown with 1 and the optimal lot size determining device, shown with 2, may be realized by a personal computer or a workstation. Alternatively, they may be realized in a mainframe. Although in FIG. 1 the sales predicting device, shown with 1 and the optimal lot size determining device, shown with 2, are represented as separate ones, they may be realized as modules in a single computer such as those mentioned above. The actual sales database, shown with 3 and the parameter database, shown with 4 may be realized as components including magnetic storage devices such as hard disks. Commercial programs for managing databases may be incorporated into such computers as mentioned above for practical use. Alternatively, a separate computer, not shown in FIG. 1, may be provided for managing a database. The computer may be realized by a personal computer, a workstation or a mainframe. Further, the devices and databases mentioned above may be connected via private lines or a public network. Further, terminals not shown may be provided at separate sites so that the terminals may be used as input/output devices at the sites. In this case, the terminals may be connected with the devices and databases mentioned above via private lines or a public network, so that the devices and databases mentioned above may totally manage the separate sites.

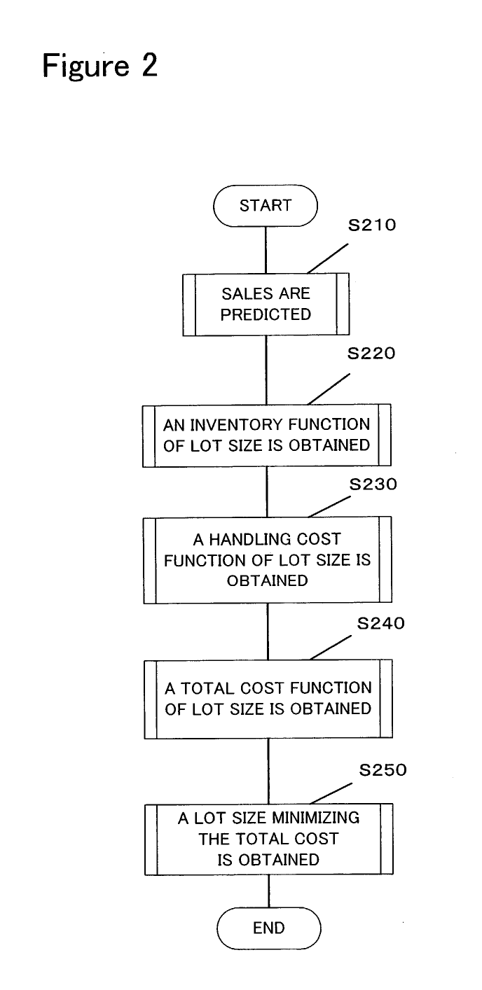

Functions of the sales predicting device, shown with 1 and the optimal lot size determining device, shown with 2, will be described as below according to the flowchart in FIG. 2.

At step S210 the sales predicting device, shown with 1, predicts sales of parts for a unit of time. The sales predicting device may predict sales by extrapolating a trend of the past sales stored in the actual sales database, shown with 3. Alternatively, a demand predicting parameter which is a function of time after a start of sales of parts and the like, may be stored in the parameter database shown with 4 so that the sales predicting device may predict sales based on the parameter. Further, the sales predicting device may predict sales based on a combination of a trend of the past sales stored in the actual sales database, shown with 3 and the demand predicting parameter stored in the parameter database shown with 4. For example, this point in time is represented as t. The point when parts were sold is represented as t−Δt and the sales of parts (actual value) at the point is represented as z(t−Δt). Further, it is assumed that a demand prediction parameter at a point after a lapse of Δt after the parts were sold, is q which depends on their estimated lifetime and the like. In this case a predicted value of sales of parts is as below.

Z=Σ[z(t−Δt)·q]

Σ represents a summation or a integration over time.

At step S220 the optimal lot size determining device, shown with 2, obtains inventory cost function G of lot size B. Inventory cost function G is a sum of cost D for storage and cost F for interest as described above. Accordingly, the following equation is obtained from equations (1) and (2).

$$\begin{matrix}G = D + F \\ = A \cdot B / 2 + I \cdot W \cdot B / 2 \\ = ( A + I \cdot W ) \cdot B / 2\end{matrix} \qquad ( 4 )$$

The optimal lot size determining device, shown with 2, uses values stored in the parameter database shown with 4, for values of A, I and W.

At step 230 the optimal lot size determining device, shown with 2, obtains dealing cost function H of lot size B. Dealing cost function H is represented as equation (3) described above.

H=(E+R)·Z/B (3)

The optimal lot size determining device, shown with 2, uses values stored in the parameter database shown with 4, for values of E and R. Further, it uses a value received from the sales predicting device, shown with 1, for a predicted value Z of sales of parts.

At step 240 the optimal lot size determining device, shown with 2, obtains total cost function J of lot size B. Total cost function J is represented as below from equations (3) and (4).

$$\begin{matrix}J = H + G \\ = ( E + R ) \cdot Z / B + ( A + I \cdot W ) \cdot B / 2\end{matrix} \qquad ( 5 )$$

At step S250 the optimal lot size determining device, shown with 2, obtains lot size B which minimizes a value of total cost function J. A differential function of total cost function J of lot size B is represented as below.

$${J}^{′} = ( A + I \cdot W ) / 2 - ( E + R ) \cdot Z / {B}^{2} \qquad ( 6 )$$

So, lot size B with which a value of J′ is equal to zero is as below.

$$B = {[ 2 \cdot ( E + R ) \cdot Z / ( A + I \cdot W ) ]}^{1 / 2} \qquad ( 7 )$$

Thus, lot size B which minimizes a value of total cost function J, is obtained.

It should be noted that total cost function J represents the total cost for parts, of the parts manufacturer and the brand manufacturer of vehicles and therefore the above total cost is minimized when total cost function J is minimized.

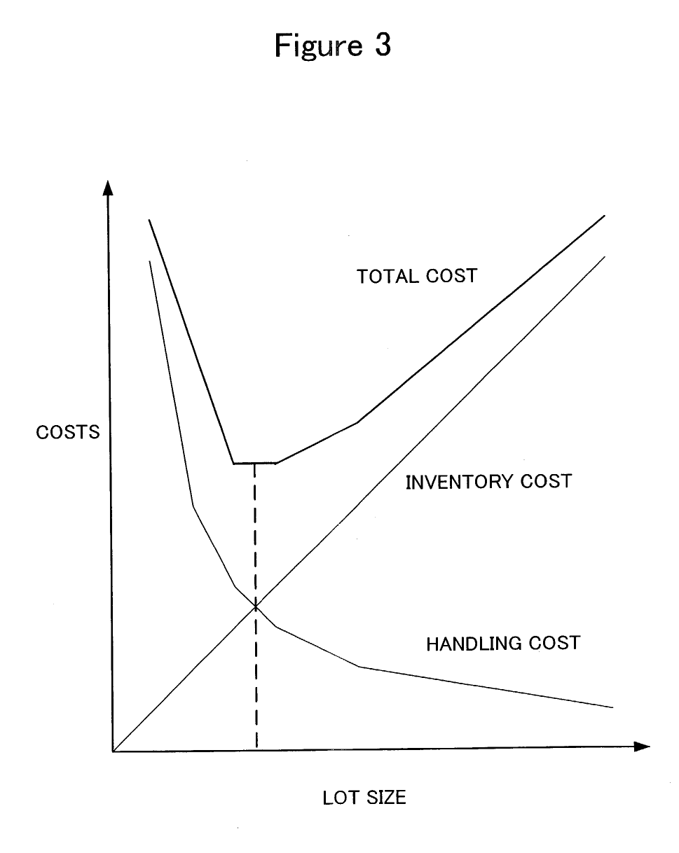

Relationships between lot size B and costs, described above, will be described below according to FIGS. 3 to 5. In FIGS. 3 to 5 the horizontal axis represents lot size B while the vertical axis represents costs. In FIGS. 3 to 5 inventory cost G, handling cost H and total cost J are shown for varying lot size B.

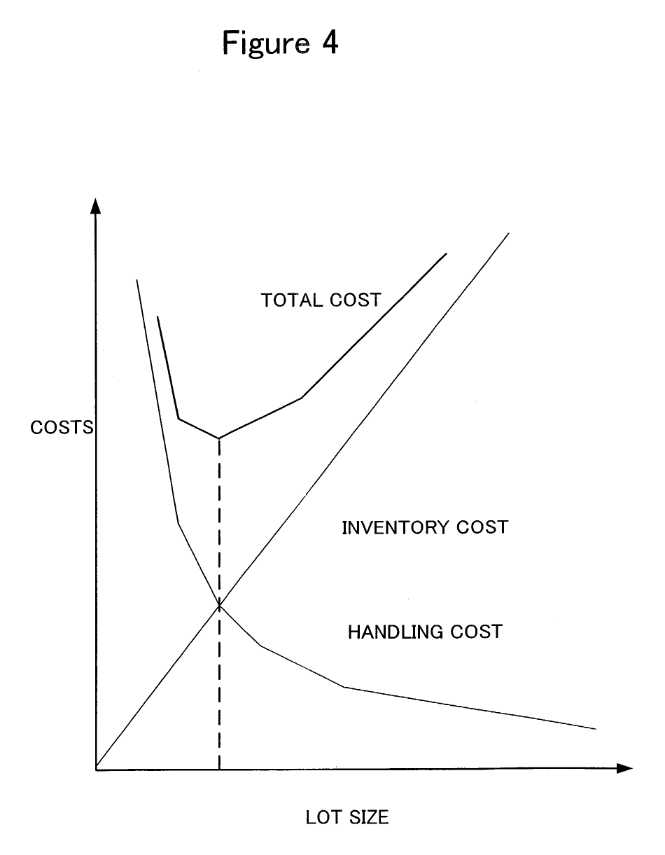

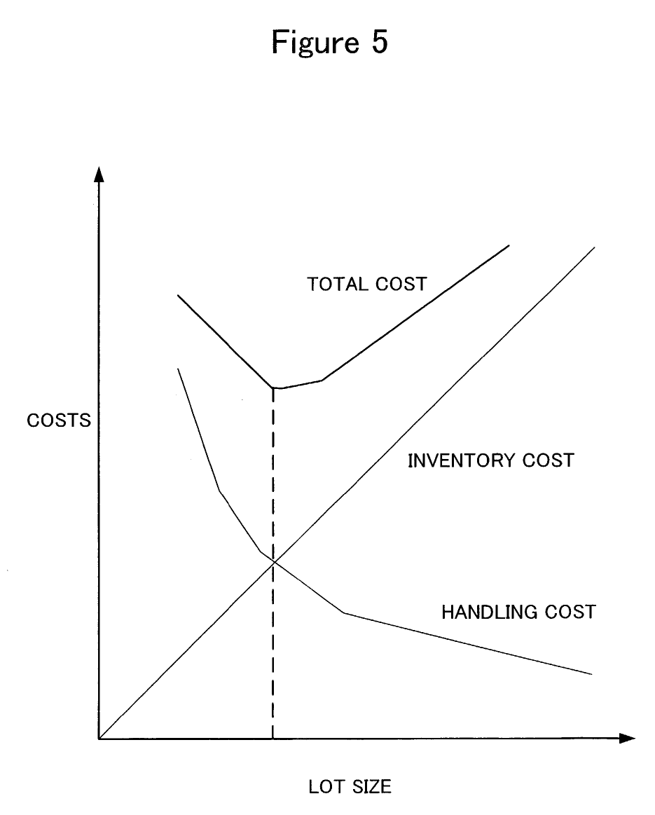

FIG. 3 shows a normal example. According to the procedure described above, an optimal value of B is obtained. FIG. 4 shows a case where handling cost H remains unchanged and cost A for storage or cost I·W for interest is greater and therefore inventory cost G is greater than in the normal example shown in FIG. 3. In FIG. 4 an inclination of the line representing inventory cost is greater than in FIG. 3. In this case, as shown in FIG. 4, an optimal value of lot size is smaller than in FIG. 3. FIG. 5 shows a case where inventory cost G remains unchanged and a predicted value of sales of parts and the like are greater and therefore handling cost H is greater than in the normal example shown in FIG. 3. In FIG. 5 the curve representing handling cost is in an upper position than in FIG. 3. In this case, as shown in FIG. 5, an optimal value of lot size is greater than in FIG. 3.

It should be noted that use of a predicted value of sales of parts for a unit of time, allows a real-time optimization of lot size B for minimizing a sum of costs. A unit of time may be appropriately defined to cope with a change in sales.

In the above description it is assumed that inventory cost function G is a sum of cost D for storage and cost F for interest. Additionally, cost X for unsold inventory may be taken into account. For example, it may be assumed that cost X for unsold inventory is proportional to the square of a period during which parts belonging to a lot in lot size B are in stock. The period is represented as B/Z. Accordingly, cost X for unsold inventory is represented as below when a parameter obtained from a empirical rule is represented with Y

X=Y·(B/Z)² (8)

Parameter Y may be stored in the parameter database, shown with 4. The optimal lot size determining device, shown with 2, may calculate cost X for unsold inventory according to equation (8) and may add the result to the value obtained through equation (4) to obtain inventory cost function G. Then the same procedure as described above will follow.

According to the present invention, use of a predicted value of sales of the item, allows a real-time optimization of lot size B for minimizing a sum of costs. Further, an optimal lot size may be determined, which minimizes a total cost including handling costs at both the sides sending and receiving lots of the item of trade.

In a preferred embodiment of the present invention, an optimal lot size that minimizes the total cost, may be determined using simple equations.

In another preferred embodiment of the present invention, an optimal lot size that minimizes a sum of costs further including cost for unsold inventory, may be determined.

What is claimed is:

1. An optimal lot size determining system comprising:
an actual sales database for storing actual sales of an item;
an item parameter database for storing parameters of the item;
an item sales predicting device, which is connected with the actual sales database and/or the item parameter database and which predicts sales of the item based on actual sales and/or parameters of the item; and
an optimal lot size determining device which is connected with the item sales predicting device and the item parameter database, which obtains an inventory cost function of lot size of the item, for costs including costs for storage and interest and a handling cost function of lot size of the item, for costs at both sides of sending and receiving the item, based on sales predicted by the item sales predicting device and item parameters and which obtains a lot size of the item, minimizing a sum of the inventory cost and the handling cost, to determine an optimal lot size.

2. An optimal lot size determining system according to claim 1, wherein the sum J of the inventory cost and the handling cost represented by the equation
$$J = ( E + R ) \cdot Z / B + ( A + I \cdot W ) \cdot B / 2$$
is defined and B is determined in such a way as to minimize J where “A” represents cost for storage of a part for a unit of time, “E” represents handling cost for a lot of the item at the receiving side of lots of the item, “R” represents handling cost for a lot of the item at the sending side of lots of the item, “W” represents a unit price of an item and “I” represents interest for a unit of time and the values of “A”, “E”, “R”, “W” and “I” are included in the item parameter database and “Z” represents a predicted value of sales of the item for a unit of time and “B” represents a lot size of the item.

3. An optimal lot size determining system according to claim 1 or 2, wherein the inventory cost further includes cost for unsold inventory risk.

4. An optimal lot size determining program used in a system comprising an actual sales database for storing actual sales of an item and an item parameter database for storing parameters of the item, for realizing the functions of:
predicting sales of the item based on actual sales stored in the actual sales database and/or parameters of the item stored in the item parameter database;
obtaining an inventory cost function of lot size of the item, for costs including costs for storage and interest and a handling cost function of lot size of the item, for costs at both sides of sending and receiving the item, based on the predicted sales and item parameters stored in the item parameter database; and
obtaining a lot size of the item, minimizing a sum of the inventory cost and the handling cost, to determine an optimal lot size.

5. An optimal lot size determining program according to claim 4, wherein the sum J of the inventory cost and the handling cost represented by the equation
$$J = ( E + R ) \cdot Z / B + ( A + I \cdot W ) \cdot B / 2$$
is defined and B is determined in such a way as to minimize J where “A” represents cost for storage of a part for a unit of time, “E” represents handling cost for a lot of the item at the receiving side of lots of the item, “R” represents handling cost for a lot of the item at the sending side of lots of the item, “W” represents a unit price of an item and “I” represents interest for a unit of time and the values of “A”, “E”, “R”, “W” and “I” are included in the item parameter database and “Z” represents a predicted value of sales of the item for a unit of time and “B” represents a lot size of the item.

6. An optimal lot size determining program according to claim 4 or 5, the inventory cost further includes cost for unsold inventory risk.

7. An optimal lot size determining method through a system comprising an actual sales database for storing actual sales of an item and an item parameter database for storing parameters of the item, the method comprising the steps of:
predicting sales of the item based on actual sales stored in the actual sales database and/or parameters of the item stored in the item parameter database;
obtaining an inventory cost function of lot size of the item, for costs including costs for storage and interest and a handling cost function of lot size of the item, for costs at both sides of sending and receiving the item, based on the predicted sales and item parameters stored in the item parameter database; and
obtaining a lot size of the item, minimizing a sum of the inventory cost and the handling cost, to determine an optimal lot size.

8. An optimal lot size determining method according to claim 7, wherein the sum J of the inventory cost and the handling cost represented by the equation
$$J = ( E + R ) \cdot Z / B + ( A + I \cdot W ) \cdot B / 2$$
is defined and B is determined in such a way as to minimize J where “A” represents cost for storage of a part for a unit of time, “E” represents handling cost for a lot of the item at the receiving side of lots of the item, “R” represents handling cost for a lot of the item at the sending side of lots of the item, “W” represents a unit price of an item and “I” represents interest for a unit of time and the values of “A”!, “E”, “R”, “W” and “I” are included in the item parameter database and “Z” represents a predicted value of sales of the item for a unit of time and “B” represents a lot size of the item.

9. An optimal lot size determining method according to claim 7 or 8, the inventory cost further includes cost for unsold inventory risk.

10. A computer readable medium having an optimal lot size determining program stored thereon for use in a system comprising an actual sales database for storing actual sales of an item and an item parameter database for storing parameters of the item, for realizing the functions of:
predicting sales of the item based on actual sales stored in the actual sales database and/or parameters of the item stored in the item parameter database;
obtaining an inventory cost function of lot size of the item, for costs including costs for storage and interest and a handling cost function of lot size of the item, for costs at both sides of sending and receiving the item, based on the predicted sales and item parameters stored in the item parameter database; and
obtaining a lot size of the item, minimizing a sum of the inventory cost and the handling cost, to determine an optimal lot size.

11. A computer readable medium according to claim 4, wherein the sum J of the inventory cost and the handling cost represented by the equation
$$J = ( E + R ) \cdot Z / B + ( A + I \cdot W ) \cdot B / 2$$
is defined and B is determined in such a way as to minimize J where “A” represents cost for storage of a part for a unit of time, “E” represents handling cost for a lot of the item at the receiving side of lots of the item, “R” represents handling cost for a lot of the item at the sending side of lots of the item, “W” represents a unit price of an item and “I” represents interest for a unit of time and the values of “A”!, “E”, “R”, “W” and “I” are included in the item parameter database and “Z” represents a predicted value of sales of the item for a unit of time and “B” represents a lot size of the item.

12. A computer readable medium according to claim 10 or 11, the inventory cost further includes cost for unsold inventory risk.
